(19) United States
(12) Patent Application Publication
(10) Pub. No.: US 2010/0140542 A1
(43) Pub. Date: Jun. 10, 2010

(54) BENZOXAZINE CONTAINING COMPOSITIONS OF MATTER AND CURABLE COMPOSITIONS MADE THEREWITH

(75) Inventors: Qing Ji, Chino Hills, CA (US); Puwei Liu, San Marcos, CA (US); My N. Nguyen, Poway, CA (US); Michael Todd, Anaheim Hills, CA (US)

Correspondence Address: Loctite Corporation, One Henkel Way, Rocky Hill, CT, 06067, US

(73) Assignee: Henkel Corporation, Rocky Hill, CT (US)

(21) Appl. No.: 12/641,569

(22) Filed: Dec. 18, 2009

Related U.S. Application Data
(63) Continuation of application No. PCT/US2007/014176, filed on Jun. 18, 2007.

(51) Int. Cl. C09K 3/00

(52) U.S. Cl. 252/182.23

(57) ABSTRACT

A composition of matter in liquid form at a temperature of 50° C. or less comprising a monofunctional benzoxazine compound embraced by the structure

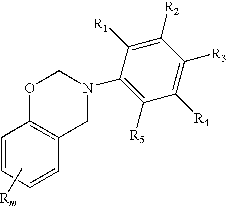

where R is a member selected from C₁₋₄₀ alkyl, C₂₋₄₀ alkenyl, each of which being optionally substituted or interrupted by one or more O, N, S, C═O, COO, and NHC═O, and C₆₋₂₀ aryl,
m is 0-4, and
R₁-R₅ are independently selected from C₁₋₁₀ alkyl, C₂₋₄₀ alkenyl, each of which being optionally substituted or interrupted by one or more O, N, S, C═O, COOH, and NHC═O, and C₆₋₂₀ aryl, and at least one of R₁-R₅ are present, is provided.

This application is a continuation under 35 U.S.C. §365(c) of International Patent Application No. PCT/US2007/014176, filed Jun. 18, 2007, which is incorporated herein by reference in its entirety.

### BACKGROUND OF THE INVENTION

1. Field of the Invention

The present invention relates to a composition of matter in liquid form at a temperature of 50° C. or less comprising a monofunctional benzoxazine compound embraced by the structure

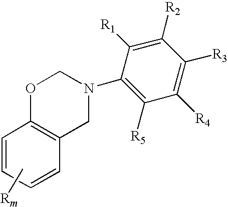

where R is a member selected from C₁₋₄₀ alkyl, C₂₋₄₀ alkenyl, each of which being optionally substituted or interrupted by one or more O, N, S, C═O, COO, and NHC═O, and C₆₋₂₀ aryl; m is 0-4; and R₁-R₅ are independently selected from C₁₋₄₀ alkyl, C₂₋₄₀ alkenyl, each of which being optionally substituted or interrupted by one or more O, N, S, C═O, COOH, and NHC═O, and C₆₋₂₀ aryl, and at least one of R₁-R₅ are present.

2. Brief Description of Related Technology

Benzoxazines are known. Blends of epoxy resins and benzoxazines are also known. See e.g. U.S. Pat. Nos. 4,607,091 (Schreiber), 5,021,484 (Schreiber), 5,200,452 (Schreiber), and 5,445,911 (Schreiber). These blends appear to be potentially useful in the electronics industry as the epoxy resins can reduce the melt viscosity of benzoxazines allowing for the use of higher filler loading while maintaining a processable viscosity. However, epoxy resins oftentimes undesirably increase the temperature at which benzoxazines polymerize.

U.S. Pat. No. 6,620,925 (Musa) is directed to and claims a curable composition comprising certain benzoxazine compounds without reactive functionality other than the benzoxazine (apart from allyl and propargyl which are disclosed but not claimed) and a curable compound or resin selected from vinyl ethers, vinyl silanes, compounds or resins containing vinyl or allyl functionality, thiolenes, compounds or resins containing cinnamyl or styrenic functionality, fumarates, maleates, acrylates, maleimides, cyanate esters, and hybrid resins containing contain both vinyl silane and cinnamyl, styrenic, acrylate or maleimide functionality.

And U.S. Pat. No. 6,743,852 (Dershem) speaks to liquid benzoxazines that may be combined with one or more of epoxy, cyante, ester, maleimides, acrylates, vinyl ethers, vinyl esters, styrenic, propargyl ethers, dialklyl amides, aromatic acetylene, benzocyclobutene, thiolene, maleate, oxazoline and itaconimide.

Ternary blends of epoxy resins, benzoxazine and phenolic resins are also known. See U.S. Pat. No. 6,207,786 (Ishida), and S. Rimdusit and H. Ishida, “Development of new class of electronic packaging materials based on ternary system of benzoxazine, epoxy, and phenolic resin,” Polymer, 41, 7941-49 (2000).

Despite the state of the art, it would be a distinct advantage for benzoxazine compounds to be in liquid form at a temperature of 50° C. or less (such as room temperature), such that little, if any, added diluent would be used for addition, blending and/or dispensing of a composition made with the benzoxazine compound. In addition, it would be desirable to provide blends of such benzoxazine compounds with additional reactants to create systems with a balance of physical properties not believed to be attainable in known curable systems.

### SUMMARY OF THE INVENTION

In its broadest sense, the present invention is directed to a composition of matter in liquid form at a temperature of 50° C. or less that includes a monofunctional benzoxazine compound. The monofunctional benzoxazine compound is embraced by the structure

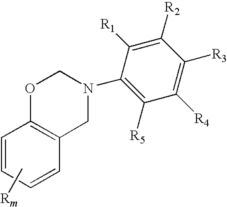

where R is selected from C₁₋₄₀ alkyl, C₂₋₄₀ alkenyl, each of which being optionally substituted or interrupted by one or more O, N, S, C═O, COO, and NHC═O, and C₆₋₂₀ aryl; m is 0-4, and R₁-R₅ are independently selected from C₁₋₄₀ alkyl, C₂₋₄₀ alkenyl, each of which being optionally substituted or interrupted by one or more O, N, S, C═O, COOH, and NHC═O, and C₆₋₂₀ aryl, and at least one of R₁-R₅ are present.

In another aspect, the present invention combines into the inventive composition of matter one or more compounds having functionality selected from cyanate ester, epoxy, episulfide, maleimide, itaconimide, nadimide, oxazline, allyl amide, acrylate, methacrylate, vinyl ether, vinyl ester, and combinations thereof with the monofunctional benzoxazine described above.

In yet another aspect, the present invention combines a multifunctional benzoxazine in liquid form (such as is shown below) with the monofunctional benzoxazine shown above, and which may optionally include the compounds noted above having functionality selected from cyanate ester, epoxy, episulfide, maleimide, itaconimide, nadimide, oxazline, allyl amide, acrylate, methacrylate, vinyl ether, vinyl ester, and combinations thereof.

### DETAILED DESCRIPTION OF THE INVENTION

As noted above, the present invention is directed to a composition of matter in liquid form at a temperature of 50° C. or less that includes a monofunctional benzoxazine compound. The monofunctional benzoxazine compound is embraced by the structure

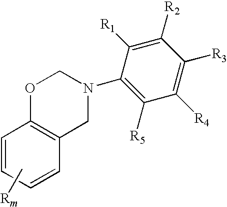

where R is selected from C₁₋₄₀ alkyl, C₂₋₄₀ alkenyl, each of which being optionally substituted or interrupted by one or more O, N, S, C═O, COO, and NHC═O, and C₆₋₂₀ aryl; m is 0-4, and R₁-R₅ are independently selected from C₁₋₄₀ alkyl, C₂₋₄₀ alkenyl, each of which being optionally substituted or interrupted by one or more O, N, S, C═O, COON, and NHC═O, and C₆₋₂₀ aryl, and at least one of R₁-R₅ are present.

Representative examples of the monofunctional

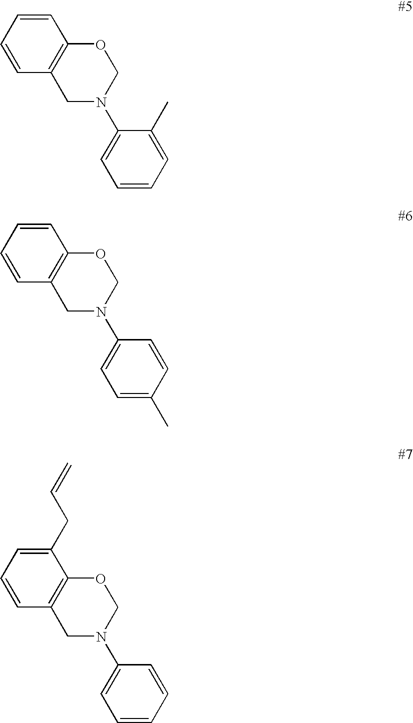

benzoxazines described include

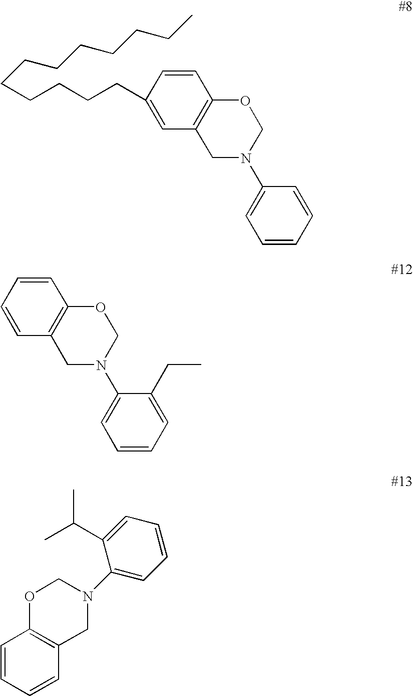

Together with these monofunctional benzoxazines may be included in the composition of matter other monofunctional benzoxazines, such as

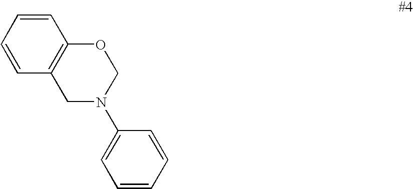

More specifically, certain combinations of monofunctional benzoxazines have been identified as particularly desirable. For instance, the two combinations of the following three monofunctional benzoxazines is noteworthy:

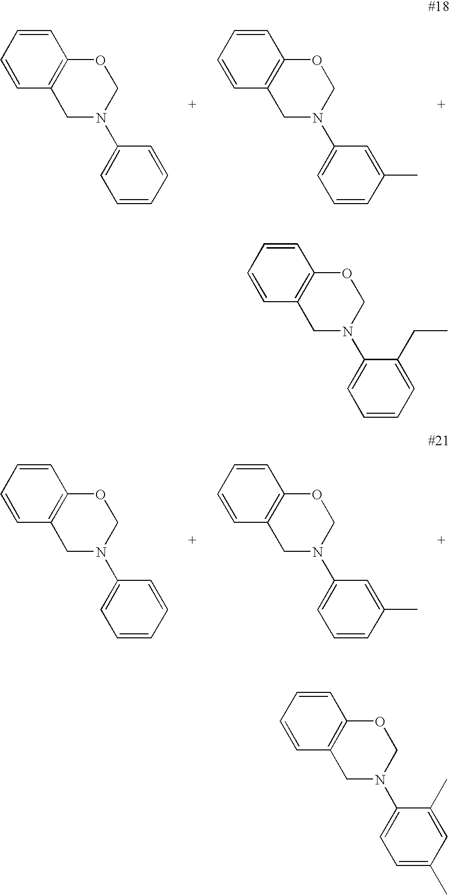

In addition, compositions of matter including compounds embraced by the following two generic structures form part of the present invention when they exist in liquid form at a temperature of 50° C. or less:

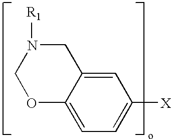

where o is 1-4, X is defined below, and R₁ is alkyl, such as methyl, ethyl, propyls or butyls, or

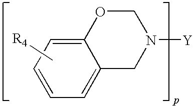

where p is 1-4, Y is defined below, and R₄ is selected from hydrogen, halogen, alkyl or alkenyl.

X and Y may independently be selected from a monovalent or polyvalent radical that include
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, and
polysiloxane-polyurethane block copolymers, and combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

The linker moieties contemplated for X and Y should have sufficient length and/or branching to render the benzoxazine compound a liquid at a temperature of 40° C. or less, such as room temperature.

When one or more of the above described “X” or “Y” groups cooperate with one or more of the above described linkers to form the appendage of a benzoxazine group, as readily recognized by those of skill in the art, a wide variety of organic chains can be produced, such as, for example, oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkynylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, carboxyheteroatom-containing di- or polyvalent cyclic moiety, and the like.

As noted above, multifunctional benzoxazines in liquid form may also be combined with the composition of matter. For instance,

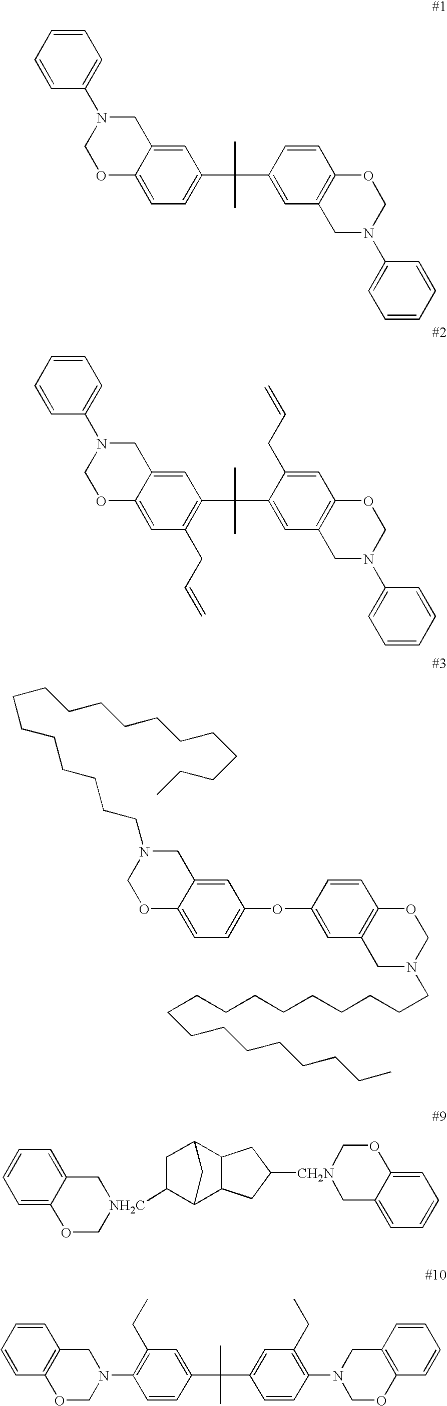

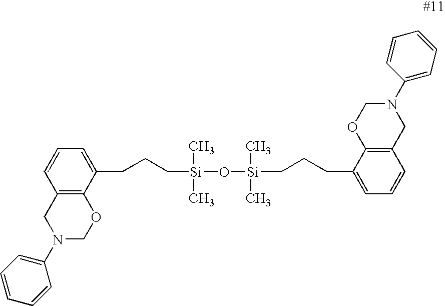

The difunctional benzoxazines numbered 3, 9 and 11 themselves also form part of the invention.

The combination of certain monofunctional benzoxazines with certain multifunctional benzoxazines was observed to be particularly desirable. For instance, the combination of these three monofunctional benzoxazines and one multifunctional benzoxazine is noteworthy:

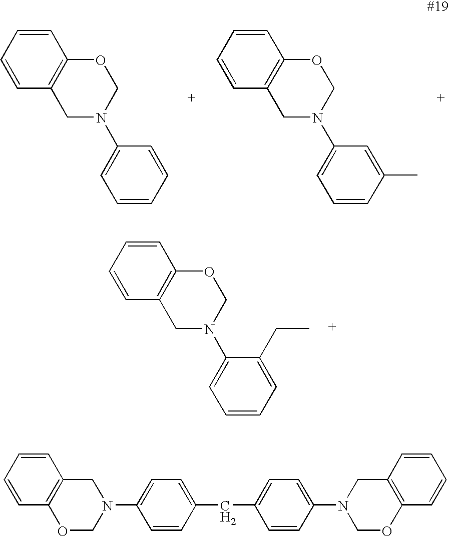

The present invention may also combine into the inventive compositions of matter one or more compounds having functionality selected from cyanate ester, epoxy, episulfide, maleimide, itaconimide, nadimide, oxazoline, allyl amide, acrylate, methacrylate, vinyl ether, vinyl ester, and combinations thereof with the monofunctional benzoxazine described above, and optionally with and the multifunctional benzoxazine also described above.

When the compound with such functionality is used, the ratio of the benzoxazine to the compound with such functionality should in a desirable embodiment be in the range of 2:1 to 25:1, such as 5:1 to 15:1, desirably 10:1 to 12:1. A particularly desirable compound with such functionality is a cyanate ester compound.

The compounds having cyanate ester functionality may be described with reference to the structure of formula I:

R¹O—C≡N)ₘ (I)

where m is from 2 to 5 and R¹ is an aromatic nucleus-containing residue. More specific examples of such compounds include 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl, bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene and cyanated, bisphenol-terminated polycarbonate or other thermoplastic oligomer.

Other cyanate esters include those disclosed in U.S. Pat. Nos. 4,477,629 and 4,528,366, the disclosure of each of which is hereby expressly incorporated herein by reference; the cyanate esters disclosed in U.K. Patent No. 1,305,702, and the cyanate esters disclosed in International Patent Publication No. WO 85/02184, the disclosure of each of which is hereby expressly incorporated herein by reference.

Particularly desirable cyanate esters for use herein are available commercially from Huntsman Specialty Chemicals, Brewster, New York under the tradename “AROCY” or from Lanza Group, Great Britain under the tradename “PRIMASET” [1,1-di(4-cyanatophenylalkanes)]. The structures of four desirable “AROCY” cyanate esters are

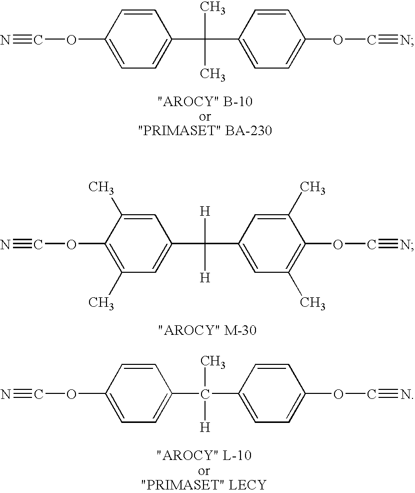

In addition,

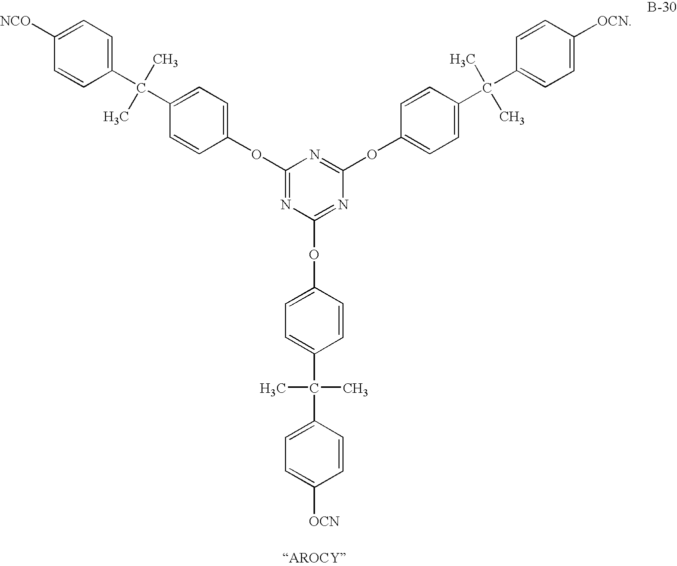

The compounds having functionality of maleimide, itaconimide, or nadimide include those described in for instance U.S. Pat. No. 6,916,856 and U.S. Patent Application Publication No. 2004/00077998, the disclosures of each of which being hereby incorporated herein by reference.

Generally, for easy handling and processing, the viscosity of a thermosetting resin composition should fall in the range of about 10 to about 12,000 centipoise (“cPs”), preferably from about 10 to about 2,000 cPs. Inventive benzoxazine compounds in the liquid form typically at a temperature of 50° C. or less. More specifically, such benzoxazines in liquid form at room temperature, have a viscosity of less than 10,000 cPs at room temperature, such as less than 150 cPs at room temperature.

Because of their flowable viscosities, these inventive benzoxazine-containing compositions of matter require no added diluent, or when diluent is used therewith, far less diluent is used to facilitate handling than must be added to conventional benzoxazine-containing thermosetting resin systems.

A diluent may be added to the inventive compositions of matter in the event that viscosity is desired to be reduced. Any diluent may be used (whether inert or reactive to the benzoxazine). Representative inert diluents include dimethylformamide, dimethylacetamide, N-methylpyrrolidone, toluene, xylene, methylene chloride, tetrahydrofuran, methyl ethyl ketone, monoalkyl or dialkyl ethers of ethylene glycol, polyethylene glycol, propylene glycol or polypropylene glycol, glycol ethers, and the like. Representative reactive diluents include acrylates and methacrylates of monofunctional and polyfunctional alcohols, vinyl compounds as described in greater detail herein, allyl amides, fumarates, maleates, styrenic monomers (i.e., ethers derived from the reaction of vinyl benzyl chlorides with mono-, di-, or trifunctional hydroxy compounds), norbornyl compounds, and the like.

The inventive compositions of matter may include a filler, such as an inorganic one, like silica for instance. Other inorganic fillers include silicon nitride, boron nitride, and metallic ones, as described below.

The filler may be a conductive filler or a non-conductive filler.

The filler when conductive may be metallic, such as silver, copper, solder particles, alumina, aluminum nitride, or alumina trihydrate.

The filler when non-conductive may be selected from (meth)acrylic particles such as poly(methylmethacrylate)s, PDMS particles, polyolefin particles, styrene particles, teflon, and glass.

The inventive compositions of matter may be formulated so that when cured they have a coeffecient of thermal expansion in the range of 15 to 35 at filler level of 50% by weight. In addition, the inventive compositions may be formulated so that when cured by exposure to a temperature of 175° C. for a period of 2 hours, exhibit a volume shrinkage of less than 0.1% by linear measurement.

In order to assist in reducing the temperature at which cure of the inventive compositions occurs or accelerate the rate of cure at the cure temperature, a catalyst may be added to the inventive compositions. For instance, cationic catalysts, acid catalysts or basis catalyst may be included. Acid catalysts may be of the Lewis acid variety or may be carboxylic acids, such as heterocyclic dicarboxylic acids. In that regard, those heterocyclic dicarboxylic acids disclosed and claimed in U.S. Pat. No. 6,376,080 (Gallo) are particularly useful to catalyze the cure of benzoxazine-containing compositions, for instance 2-(2-benzthiazolyl)-succinic acid and (2-benzthiazolylthio)-butanedioic acid available under the respective tradenames IRGACOR 252LD and 252FC from Ciba Specialty Chemicals.

The inventive compositions of matter are useful for formulating into compositions intended as an underfill, an encapsulant, a mold compound or a die attach.

### EXAMPLES

### Example 1

Benzoxazines in liquid form in accordance with this invention may be prepared as follows:

Aniline (93 g, 1.0 mol), paraformaldehyde (60.0 g, 2.0 mol), phenol (94.0 g, 1.0 mol), and toluene (2000 ml) were placed into a 5000 ml three-neck round-bottom flask with a mechanical stir. A Dean Stark moisture-receiving trap together with a condenser were used to collect water generated from this reaction. This mixture was heated to reflux for a period of time of 4 hours while stirring was continued. A total amount of 36 ml (2.0 mol) of water was collected. The reaction mixture was allowed to cool to room temperature and passed through a thin layer of silica gel. Then, solvent was removed by rotary evaporation and the residue liquid was sparged with nitrogen gas for a period of time of 4 hours. The final product (Benzoxazine #4) was obtained as a slightly red liquid in a yield of 96%.

### Example 2

A composition of matter within the scope of this invention was prepared by adding with mixing a benzoxazine to a cyanate ester and silica to yield a system that has viscosity of 8,000 cPs at room temperature, which decreased to 200 cPs at a temperature of 90° C., and can be cured at a temperature of 175° C. for a period of time of 2 hours. Such a composition was prepared from 45.5% Benzoxazine #4, 4.5% cyanate ester (L-10) and 50.0% silica (FL-1950), each of which on a by weight basis.

After curing on test specimens at a temperature of 175° C. for a period of time of 4 hours, the now cured sample was observed to have a Tg of 135° C. (measured by way of thermal mechanical analysis), a CTE of 23.6 ppm, a modulus at room temperature of 6.9 Gpas (which decreased to about 20 Mpas at a temperature above 180° C.), shrinkage after cure of 0.07%, and strong adhesion as shown in Table 1 below.

An assembly was prepared using ceramic substrates with 300 mil die with the composition disposed between the die and the substrate. This assembly was cured at a temperature of 175° C. for a period of time of 2 hours and 4 hours, respectively. The assembled parts were then placed into pressure bombs covered with water, which were then placed into an oven maintained at a temperature of 121° C. for a period of time of 96 hours. The results set forth below in Table 1 show strong adhesion below Tg (135° C.)

TABLE 1

| | Physical Properties | | | | | | |
|---|---|---|---|---|---|---|---|
| Parts | Die Shear (Kg) | | | | | | |
| Exposed | | | | r.t. | 125° C. | 245° C. | |
| by Time | r.t. | | die | after | after | after | Moisture |
| (hours) | 125° C. | 245° C. | shear | PCT | PCT | PCT | Abs. (%) |
| 2 | >100 | >100 | 10.45 ± 1.9 | 60.2 ± 0.7 | — | 5.00 ± 1.1 | ~1.91 |
| 4 | >100 | >100 | 10.07 ± 0.4 | 58.9 ± 6.7 | — | 4.96 ± 1.5 | ~1.87 |

A value greater than 100 Kg indicates that the force exceeded the maximum that can be evaluated on the die shear machine used to conduct the evaluation.

Thus, the die shear evaluations shown in Table 1 illustrate very good performance properties, coupled with low moisture uptake values.

In a shrinkage evaluation, the composition of Example 2 was cured in a steel mold at a temperature of 175° C. for a period of time of 2 hours. The composition of Example 2 demonstrated a shrinkage value of 0.07%. This low degree of shrinkage is also a very promising physical property.

### Example 3

In this example, benzoxazine #1B was combined with a dicarboxylic acid catalyst—IRGACOR LD252—at a 1% by weight level to create Sample A. Two additional samples—Samples B and C—were prepared from Sample A, but were filled with 50% and 60% silica, respectively. Once cured at a temperature of 165° C. for a period of time of 4 hours, the CTE values of Samples A, B and C were observed to be 48, 25 and 22, respectively.

### Example 4

In this example, benzoxazine #12 was combined with IRGACOR LD252 at a 1% by weight level to create Sample D. Once cured at a temperature of 165° C. for a period of time of 4 hours, the CTE value for Sample D was observed to be 47.

In addition, benzoxazine #12 was used as the basis for a CTE evaluation with and without a cyanate ester—AROCY L10 or L31—and silica at various loading levels. Reference to Table 2 below shows the loading level and the CTE values observed after curing cured at a temperature of 175° C. for a period of time of 4 hours.

TABLE 2

| | CTE | | | |
|---|---|---|---|---|
| Formulations | 0% silica | 50% silica | 60% silica | 65% silica |
| BOZ #12 | 48 | | | |
| BOZ #12 + L10 | 46 | 22 | 17 | 14 |
| BOZ #12 + L31 | 48 | 23 | 18 | 13 |

What is claimed is:

1. A composition of matter in liquid form at a temperature of 50° C. or less comprising a monofunctional benzoxazine compound embraced by the structure 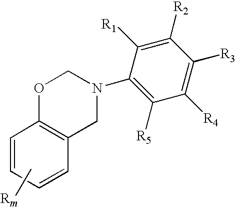
wherein R is a member selected from the group consisting of C₁₋₄₀ alkyl, C₂₋₄₀ alkenyl, each of which being optionally substituted or interrupted by one or more O, N, S, C═O, COO, and NHC═O, and C₆₋₂₀ aryl,
m is 0-4, and
R₁-R₅ are independently selected from the group consisting of C₁₋₄₀ alkyl, C₂₋₄₀ alkenyl, each of which being optionally substituted or interrupted by one or more O, N, S, C═O, COOH, and NHC═O, and C₆₋₂₀ aryl, and at least one of R₁-R₅ are present, further comprising a compound having functionality selected from the group consisting of cyanate ester, epoxy, episulfide, maleimide, itaconimide, nadimide, oxazline, allyl amide, acrylate, methacrylate, vinyl ether, vinyl ester, and combinations thereof.

2. The composition of claim 1, in liquid form at room temperature.

3. The composition of claim 1, having a viscosity of less then 10,000 cPs at room temperature.

4. The composition of claim 1, having a viscosity of less then 150 cPs at room temperature.

5. The composition of claim 1, wherein the compound has cyanate ester functionality and the ratio of the benzoxazine to the cyanate ester is in the range of 2:1 to 25:1.

6. The composition of claim 1, further comprising a filler.

7. The composition of claim 1, when cured has a coeffecient of thermal expansion in the range of 15 to 35 at filler level of 50% by weight.

8. The composition of claim 1, when cured by exposure to a temperature of 175° C. for a period of 2 hours has a volume shrinkage of less than 0.1% by linear measurement.

9. A composition of matter in liquid form at a temperature of 50° C. or less comprising a monofunctional benzoxazine compound embraced by the structure 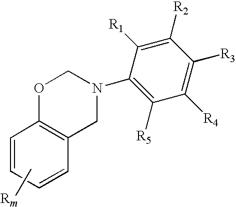
wherein R is a member selected from the group consisting of C₁₋₄₀ alkyl, C₂₋₄₀ alkenyl, each of which being optionally substituted or interrupted by one or more O, N, S, C═O, COO, and NHC═O, and C₆₋₂₀ aryl,
m is 0-4, and
R₁-R₅ are independently selected from the group consisting of C₁₋₄₀ alkyl, C₂₋₄₀ alkenyl, each of which being optionally substituted or interrupted by one or more O, N, S, C═O, COOH, and NHC═O, and C₆₋₂₀ aryl, and at least one of R₁-R₅ are present further comprising a multifunctional benzoxazine.

10. The composition of claim 9, comprising the combination of

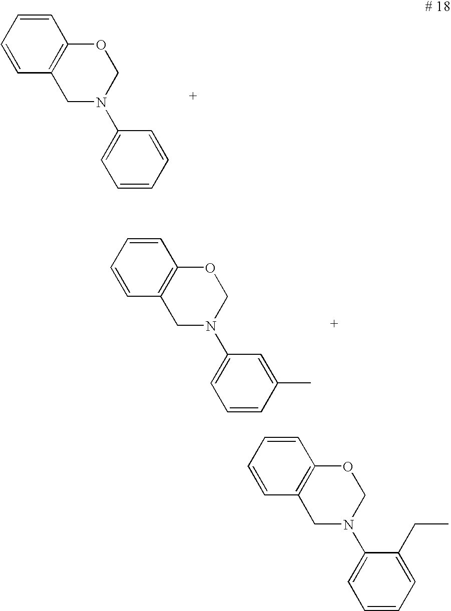

11. The composition of claim 10, comprising the combination of

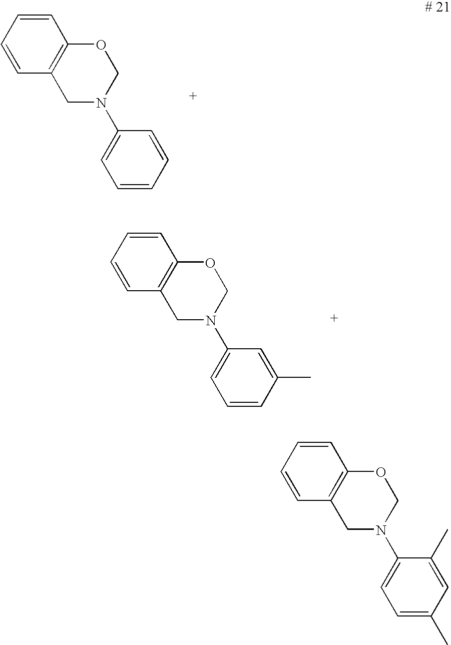

12. The composition of claim 8, wherein the multifunctional benzoxazine is in liquid form.

13. The composition of claim 1, wherein the cyanate ester compound has the structure of formula I:
R¹O—C≡N)ₘ (I)
wherein m is from 2 to 5 and R¹ is an aromatic nucleus-containing residue.

14. The composition of claim 1, wherein the cyanate ester compound 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl, bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene and cyanated, bisphenol-terminated polycarbonate or other thermoplastic oligomer.

15. The composition of claim 1, comprising the combination of

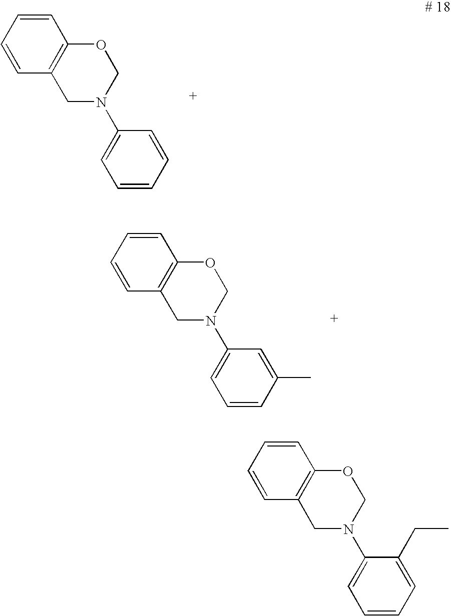

16. The composition of claim 1, comprising the combination of [chemical structure]
